(19) United States
(12) Patent Application Publication
(10) Pub. No.: US 2024/0192988 A1
(43) Pub. Date: Jun. 13, 2024

(54) EXTENSIBLE PROTECTED OPEN DATA FRAMEWORK

(71) Applicant: BAE SYSTEMS INFORMATION AND ELECTRONIC SYSTEMS INTEGRATION INC., Nashua, NH (US)

(72) Inventors: Zachary A. Maynard, Nashua, NH (US); Michael F. Roske, Milford, NH (US); Charles C. Gasdick, Milford, NH (US)

(73) Assignee: BAE SYSTEMS INFORMATION AND ELECTRONIC SYSTEMS INTEGRATION INC., Nashua, NH (US)

(21) Appl. No.: 18/080,444

(22) Filed: Dec. 13, 2022

(51) Int. Cl. G06F 9/48; G06F 9/54; G06F 16/2453

(52) U.S. Cl. CPC G06F 9/4881; G06F 9/544; G06F 16/24532

(57) ABSTRACT

An extensible open data framework asynchronously processes augments received in response to alterations in registered triggers. The framework includes an active data storage and an algorithm execution protocol. The active data storage includes short term data signals and long term data augments or emitter tracks. The execution protocol includes an execution thread pool having multiple threads that operate in parallel. The parallelization of the algorithm via the execution thread pool scales through multiple threads and cores to process data.

### TECHNICAL FIELD

The present disclosure relates generally to signal processing techniques, protocols and frameworks.

### BACKGROUND

Some electronic systems, such as electronic warfare (EW) systems, utilize lists or pipeline/serial processing in software that manage various data streams. For example, radio frequency (RF) sensors detect RF energy that is used to construct emitter tracks from signal emitters or that represent signals, objects or entities of interest. Then, the track is used by the EW system to perform other actions. For example, the track may be used by the EW system to deploy a countermeasure or instruct the platform to perform an evasive maneuver.

Some improvements have considered the use of databases populated with signal data. However, databases have been found to be too slow when processing speed is critical to process incoming data streams including tracks of data from a signal emitter.

Others have attempted to develop in-memory databases. One example is the Redis in-memory data store that enables low latency and high throughput data access. Redis, which stands for Remote Dictionary Server, is a fast, open source, in-memory, key-value data store. However, the Redis in-memory data store, while beneficial for some particular purposes, does not solve the needs for EW systems based on the amount of data generated from various signal emitters. Entity component systems include components, such as various characteristics of information stored therein. A signal entered into the system creates a new entity.

### SUMMARY

The present disclosure addresses the problems associated with processing data in electronic systems quickly that could not be solved via the previous lists/pipeline techniques or through the use of a traditional in-memory database. The present disclosure addresses these issues by providing an in-memory database (i.e., running in Random Access Memory (RAM)) that enables data to be accessed on every individual entry in the in-memory database and modify those entries individually or in batches. The present disclosure presents an algorithm execution framework that provides an in-memory database or data store that any number of algorithms can access that enables events to occur in any order as opposed to the traditional pipeline/serial occurrence.

The present disclosure provides a framework that modernizes an EW system with different ways to trigger the data, different ways to access the data and notifications that notify when data is updated. The framework coordinates with an entity component system. The framework allows the system to run arbitrary algorithms using a database. The framework effectively provides a shell that enables an algorithm, in the format of an open application program interface (API) to be swapped out as necessary and allow the framework to still operate with a different algorithm. Essentially, the API will instruct the database the type of data it needs to know or determine, receive triggers from the database when those actions occur, and then request the database through queries. When that data is returned, the framework will execute the algorithm.

In one aspect, an exemplary embodiment of the present disclosure may provide a computer implemented method for asynchronous signal processing, the method comprising: providing or obtaining a framework comprising an active data storage and an execution protocol, wherein the execution protocol is coupled with the active data storage; registering a trigger and transmitting the registered trigger to a trigger list in the active data storage, wherein the trigger is associated with an augment stored in a database in the active data storage; determining that the trigger has changed in response to one or more signals received into the active data storage; retrieving augment data from the active data storage in response to the determination that the trigger has changed; receiving the retrieved augment data in the execution protocol; providing the received and retrieved augment data to an execution thread pool, wherein the execution thread pool includes multiple execution threads that operate in parallel to execute multiple instances of algorithms at the same time; executing one or more algorithms on different but parallel threads of the execution thread pool at the same time, wherein execution of at least one of the two algorithms is based on the received and retrieved augment data. This exemplary embodiment or another exemplary embodiment may further provide, wherein executing at least two algorithms on different but parallel threads of the execution thread pool at the same time comprises: receiving signals via a sensor or digital receiver on the platform from a first signal generator remote from platform; receiving signals via a digital receiver or sensor from a second signal generator remote from the platform; executing, via a first application program interface (API), a first algorithm in a first thread of the execution thread pool based on augments associated with the signals received from the first signal generator; executing, via the API, a second algorithm in a second thread of the execution thread pool based on augments associated with the signals received from the second signal generator, wherein the second thread operates in parallel with the first thread in the execution thread pool. This exemplary embodiment or another exemplary embodiment may further provide determining whether one of the threads in the execution thread pool is occupied by that thread executing another algorithm, and if that thread is occupied then executing, via another API, another algorithm in another thread that operates in parallel with the thread that is occupied. This exemplary embodiment or another exemplary embodiment may further provide, wherein there are, for example, at least five threads that operate in parallel for execution of algorithms utilizing the received and retrieved data that is received into the execution protocol based on registered triggers from one of the first algorithm and the second algorithm. This exemplary embodiment or another exemplary embodiment may further provide buffering the received and retrieved augment data in the event that all of threads are occupied. This exemplary embodiment or another exemplary embodiment may further provide removing the first algorithm from the first thread; and inserting a third algorithm into the first thread to replace the first algorithm. This exemplary embodiment or another exemplary embodiment may further provide retrieving the augment based on an identifier; and providing only the identifier and the augment to a first application program interface (API) for executing a first algorithm. This exemplary embodiment or another exemplary embodiment may further provide wherein the registered trigger is different than the augment to be retrieved. This exemplary embodiment or another exemplary embodiment may further provide querying data in the active data storage via persistent queries that are asynchronous to the registered trigger; and comparing queried data with the received and retrieved augment data associated with the trigger. This exemplary embodiment or another exemplary embodiment may further provide scheduling the persistent queries to query data in the active data storage at regular intervals. This exemplary embodiment or another exemplary embodiment may further provide maintaining a local copy of data in the active data storage so that the persistent queries do not need to constantly poll the active data storage.

This exemplary embodiment or another exemplary embodiment may further provide running multiple algorithms concurrently, on multiple threads, and provide inputs/updates to the active data storage (augments) from each thread, and include updating the same augments.

In another aspect, an exemplary embodiment of the present disclosure may provide a framework for asynchronous signal processing, the framework comprising: an active data storage including a first data storage and a second data storage, wherein the first data storage includes data signals and the second data storage includes augments; and the active data storage further including a trigger list and a request handler; and an execution protocol, wherein the execution protocol is coupled with the active data storage; and the execution protocol including a registered trigger, a trigger receiver, a data requester, and a data receiver; and the execution protocol including an execution thread pool having at least two parallel threads, wherein the least two parallel threads asynchronously execute two algorithms, respectively, based on the augments. This exemplary embodiment or another exemplary embodiment may further provide a application program interface (API) for executing a first algorithm in a first thread that is one of the least two parallel threads of the execution thread pool based on augments associated with signals received from a first signal generator located remote from a platform; and the API executes a second algorithm in a second thread that is one of the least two parallel threads of the execution thread pool based on augments associated with signals received from a second signal generator located remote from the platform. This exemplary embodiment or another exemplary embodiment may further provide an identifier associated with each of the augments, wherein execution on at least one of the two algorithms is based, at least in part, on the identifier. This exemplary embodiment or another exemplary embodiment may further provide a persistent query coupled to the data requester.

In yet another aspect, an exemplary embodiment of the present disclosure may provide a computer program product including least one non-transitory computer readable storage medium in operative communication with a processor and a framework comprising an active data storage and an execution protocol, wherein the execution protocol is coupled with the active data storage, the storage medium having instructions stored thereon that, when executed by the processor implement a method for asynchronous signal processing, the instructions comprising: register a trigger and transmitting the registered trigger to a trigger list in the active data storage, wherein the trigger is associated with an augment stored in a database in the active data storage, wherein the trigger changes in response to one or more signals received into the active data storage; retrieve augment data from the active data storage in response to the trigger changing; receive the retrieved augment data in the execution protocol; provide the received and retrieved augment data to an execution thread pool, wherein the execution thread pool includes multiple execution threads that operate in parallel to execute multiple instances of algorithms at the same time; and execute one or more algorithms on different but parallel threads of the execution thread pool at the same time, wherein execution of at least one of the two algorithms is based on the received and retrieved augment data. This exemplary embodiment or another exemplary embodiment may further provide that the instructions further comprise: receive signals at a first digital receiver on a platform from a first signal generator remote from the platform; receive signals from a second signal generator remote from the platform; execute, via a first API, a first algorithm in a first thread of the execution thread pool based on augments associated with the signals received from the first signal generator; execute, via the first API, a second algorithm in a second thread of the execution thread pool based on augments associated with the signals received from the second signal generator, wherein the second thread operates in parallel with the first thread in the execution thread pool. This exemplary embodiment or another exemplary embodiment may further provide that the instructions further comprise: determine whether one of the threads in the execution thread pool is occupied by that thread executing another algorithm, and if that thread is occupied then executing, via another API, another algorithm in another thread that operates in parallel with the thread that is occupied; and buffer the received and retrieved augment data in the event that all of threads are occupied. This exemplary embodiment or another exemplary embodiment may further provide that the instructions further comprise retrieve the augment based on an identifier; and provide only the identifier and the augment to the first API for executing a first algorithm. This exemplary embodiment or another exemplary embodiment may further provide that the instructions further comprise: query data in the active data storage via persistent queries that are asynchronous to the registered trigger; and compare queried data with the received and retrieved augment data associated with the trigger. This exemplary embodiment or another exemplary embodiment may further provide that the wherein instructions further comprise: schedule the persistent queries to query data in the active data storage at regular intervals; and maintain a local copy of data in the active data storage so that the persistent queries do not need to constantly poll the active data storage. This exemplary embodiment or another exemplary embodiment may further provide that the instructions further comprise: provide feedback to the active data storage in response to execution of the at least two algorithms on different but parallel threads of the execution thread pool at the same time; and change an augment in the active data storage in response to the feedback, wherein changing the augment is accomplished by inserting additional data into the augment that was produced during execution of the at least two algorithms on different but parallel threads of the execution thread pool at the same time.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of a platform carrying an exemplary extensible protected open data framework of the present disclosure while traveling over an environment.

FIG. 2 (FIG. 2) is an enlarged schematic view of a portion of the platform carrying the exemplary extensible protected open data framework as highlighted by the dashed circle labeled “SEE FIG. 2” from FIG. 1

FIG. 3 (FIG. 3) is a schematic flow chart of the exemplary extensible protected open data framework.

Similar numbers refer to similar parts throughout the drawings.

### DETAILED DESCRIPTION

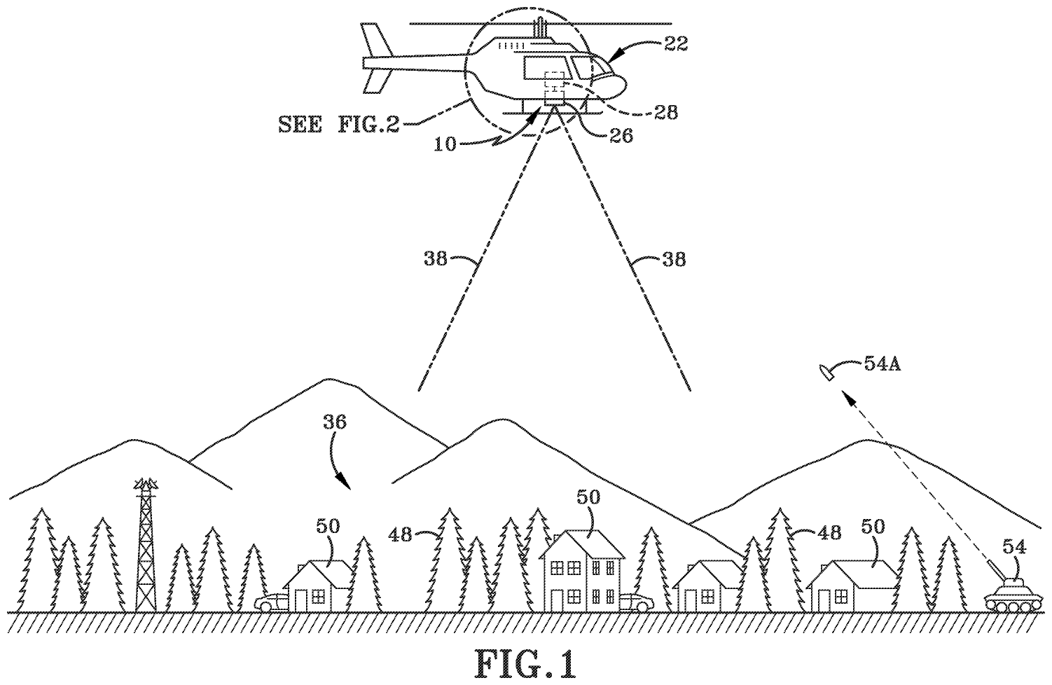

FIG. 1 diagrammatically depicts a system for an extensible protected open data framework. The system includes a framework 10, a platform 22 that includes at least one sensor 26 and at least one processor 28. Sensor 26 may be an electronic warfare (EW) sensor or digital receiver, however other sensors are entirely possible.

In accordance with one aspect of the present disclosure, the platform 22 may be any moveable platform configured to be elevated relative to a geographic landscape 36. Some exemplary moveable platforms 22 include, but are not limited to, unmanned aerial vehicles (UAVs), manned aerial vehicles, projectiles, guided projectiles, or any other suitable moveable platforms.

When the platform 22 is embodied as a moveable aerial vehicle, the platform 22 may include a front end or a nose opposite a rear end or tail. Portions of the EW system may be mounted to the body, the fuselage, or internal thereto between the nose and tail of the platform 22. While FIG. 1 depicts that some portions of the EW system are mounted or carried by the platform 22 adjacent a lower side of the platform 22, it is to be understood that the positioning of some components may be varied and the figure is not intended to be limiting with respect to the location of where the components of the system enabled by framework 10 are provided. For example, and not meant as a limitation, the at least one sensor 26 is mounted on the platform 22. Furthermore, some aspects of the at least one sensor 26 may be conformal to the outer surface of the platform 22 while other aspects of the at least one sensor 26 may extend outwardly from the outer surface of the platform 22 and other aspects of the at least one sensor 26 may be internal to the platform 22.

In one non-limiting example, the at least one sensor 26 may be a digital RF receiver on the lower side of the platform 22. The at least one sensor 26 is configured to observe or sense scenes remote from the platform 22, such as, for example, a geographic landscape 36 within its field of view (FOV) 38.

While the FOV 38 in FIG. 1 is directed vertically downward towards the geographic landscape 36, it is further possible for a system in accordance with the present disclosure to have a sensor 26 that projects its FOV 38 outwardly and forwardly from the nose of the platform 22 or outwardly and rearward from the tail of the platform 22, or in any other suitable direction. However, as will be described in greater detail below, certain implementations and embodiments of the present disclosure are purposely aimed downward so as to sense a scene from the geographic landscape 36 to be used to provide navigation and/or position and/or location and/or geolocation information to the platform 22. Generally, the sensor 26 has an input and an output. An input to the sensor 26 may be considered the scene image observed by the FOV 38 that is processed through the imagery or sensing components within the sensor 26. An output of the sensor may be an image captured by the sensor 26 that is output to another hardware component or processing component.

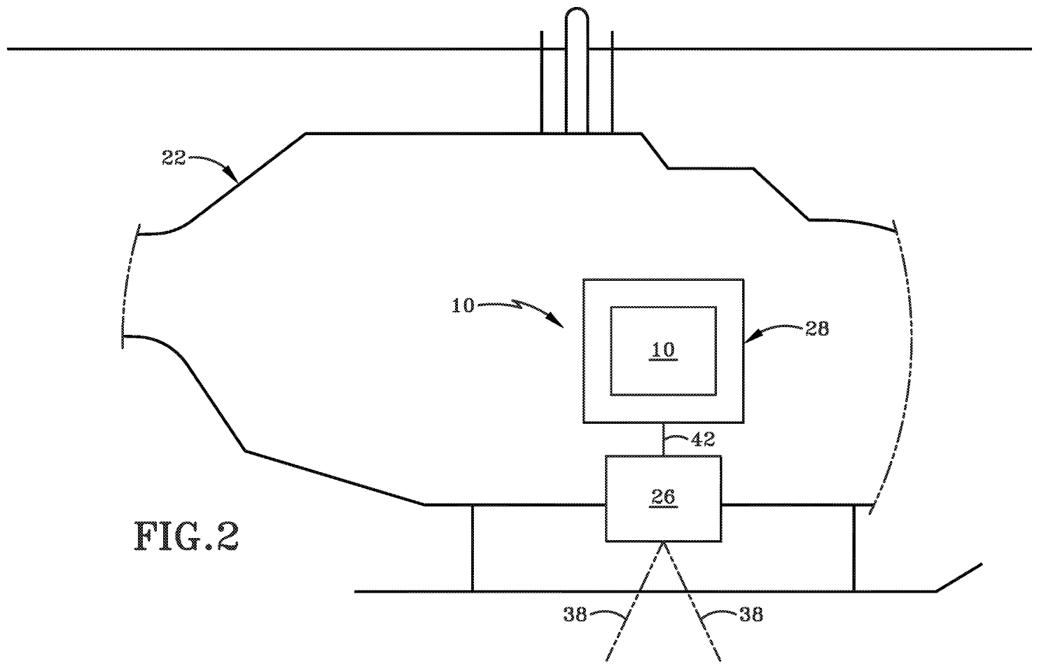

FIG. 2 depicts the at least one processor 28 is in operative communication with the at least one sensor 26. More particularly, the at least one processor 28 is electrically connected with the output of the sensor 26. In one example, the at least one processor 28 is integrally formed within sensor 26. In another example, the processor 28 is directly wired the output of the sensor 26. However, it is equally possible for the at least one processor 28 to be wirelessly connected to the sensor 26. Stated otherwise, a link 42 electrically connects the sensor 26 to the at least one processor 28 (which may be entirely physically internal to the housing associated with sensor 26) and may be any wireless or wired connection, integral to the sensor 26 or external to sensor 26, to effectuate the transfer of digital information or data from the sensor 26 to the at least one processor 28. The at least one processor 28 is configured to or is operative to generate a data signal in response to the data received over the link 42 from the sensor 26.

With continued reference to FIG. 1, and having thus described the general structure of the system for framework 10, reference is now made to features of the geographic landscape 36. For example, and not meant as a limitation, the geographic landscape 36 may include natural features 48, such as trees, vegetation, or mountains, or manmade features 50, such as buildings, roads, or bridges, etc., which are viewable from the platform 22 through the FOV 38 of the sensor 26. Also within the FOV 38 is a candidate object 54, which may be a threat or another object of interest 54A.

The system can use the sensor 26 to capture a received signal from a signal generator located remote from the platform in a scene remote from the platform 22, such as object 54 or threat 54A. The at least one processor 28 generates data in response to the sensor 26 capturing the signal. Metadata may be provided for each captured signal. For example, and not meant as a limitation, the metadata may include, a latitude position of the platform 22 in radians, a longitude position of the platform 22 in radians, an altitude position of the platform 22 in meters, a velocity of the platform 22 in meters per second, and a rotation of the platform 22 in degrees. Further, the metadata may include the a latitude position of the object 54 or threat 54A in radians, a longitude position of the object 54 or threat 54A in radians, an altitude position of the object 54 or threat 54A in meters, a velocity of the object 54 or threat 54A in meters per second, and a rotation of the object 54 or threat 54A in degrees. Metadata associated with the at least one sensor 26 may also be provided, such, as, for example, mounting information related to the at least one sensor 26. Although examples of metadata have been provided, it is to be understood that the metadata may include any suitable data and/or information.

Framework 10 provides a framework, system and/or architecture detailed herein implementing identified techniques, protocols, and processes that (i) result in improvements in computer functionality, (ii) are a specific non-conventional and non-generic arrangements of components to overcome an existing problem, and (iii) the method(s) or process(es) detailed herein are an ordered combination of steps using unconventional rules different than previously used.

By way of one example, as detailed herein, the present disclosure identifies an improvement to computer functionality. Namely, the framework, techniques, protocols, and processes are directed to improving the universality of a protected computer open data framework network. In one example, this is accomplished through a common framework for algorithm execution using an organized, shared data store. The present disclosure separates algorithm execution from the data storage in an embedded application to provide, amongst other things, algorithm-agnostic data structures (augments) that allow algorithms to be added or removed without a complete rebuild of data storage. In this example, there is time-sensitive data storage (signals) having time windowed storage with algorithm notification(s) if an execution protocol requests expired data. There is an open interface for third party developers to generate business logic without a need to understand details of data storage. The present disclosure provides protected data access outside of the algorithm execution. Further, there is a controlled pool of execution threads to manage compute resources provided to independent algorithms. This also allows multiple copies of any algorithm to run in parallel (as supported by the business logic). These features provide a specific solution to the data-network problem created by running multiple data sets with ansynchronous signal for controlled data retrieval.

Additionally, by way of another example, the arrangement of components detailed herein is an unconventional arrangement that does more than simply process data. For example, the arrangement of purposefully placing the algorithm for execution in the execution thread pool and separate from the active data storage enables the system or method of the present disclosure to work with any type of algorithm or protocol whereas previous techniques were application specific. This enables the system or method of the present disclosure to be simpler to install, execute, and require minimal changes to swap-out the algorithms that are being executed. This results in a faster installation and may reduce errors that are sometimes common to interfacing various protocols or algorithms together. This is also a solution in computer networks that operates in a manner that deviates from normal expected operations.

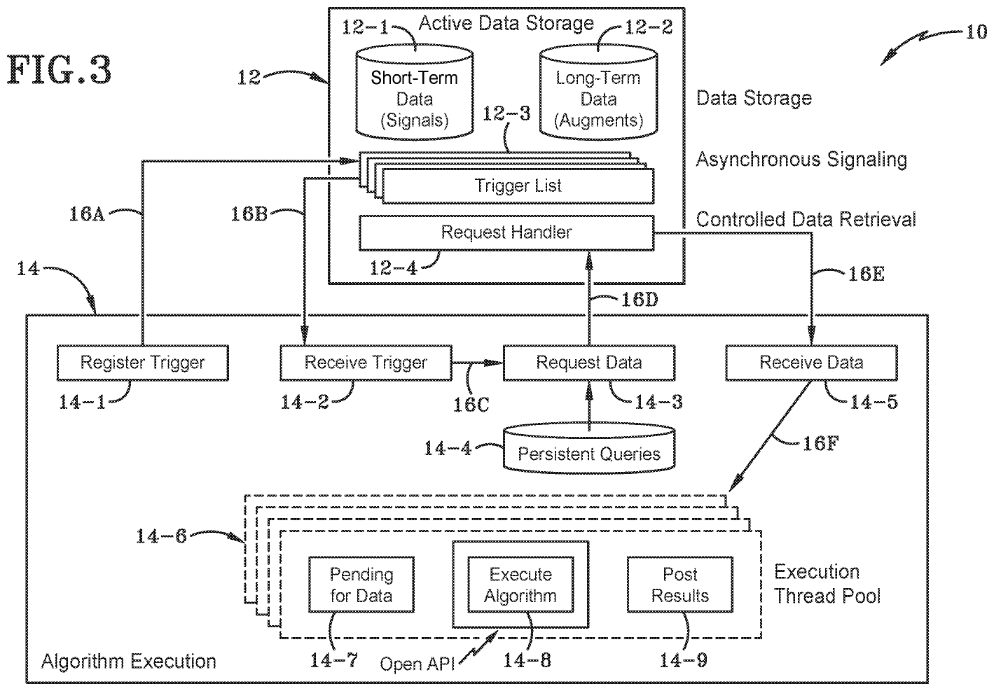

FIG. 3 details an exemplary framework generally at 10 according to an exemplary embodiment of the present disclosure. Framework 10 includes an active data storage (ADS) 12 and an execution protocol 14. ADS 12 may include short-term data 12-1, long-term data 12-2, a trigger list 12-3, and a request handler 12-4. The execution protocol 14 may include a registered trigger 14-1, a received trigger 14-2, requested data 14-3, persistent queries 14-4, received data 14-5, an execution thread pool 14-6, a pending for data queue 14-7, an algorithm execution call 14-8, and results posting 14-9.

Various components of framework 10 are connected or coupled, either directly or indirectly, via links 16. Notably, the links 16 described herein are designated with the reference numeral 16 preceding a letter (i.e., 16A, 16B, 16C, 16D, 16E, 16F, etc.), may be any type of wired or wireless electrical connections capable of transmitting data between two or more components of framework 10.

Within the ADS 12, the long-term data 12-2 may be an entity component system (ECS). The ECS, which is represented by long-term data 12-2, as well as the short-term data 12-1 operate in-memory or via random access memory (RAM). Together, short-term data 12-1 and long-term data 12-2 (the ECS) are part of the ADS 12 which, in one exemplary embodiment, is effectively a software application. The distinction and difference between short-term data 12-1 and long-term data 12-2 are that the long-term data 12-2 such as the components and augments of the entity component system, such as a frequency augments, or a geolocation augment, or pulse width augments, or pulse repetition intervals (PRI) augments or other types of data that can be stored for an emitter instance. The short-term data signals located in short-term data 12-1 are data signals received from hardware in the form of a message that describes a signal. However, the short-term data signals are often large and include all the data that is already located in the augments. Thus, aspects of the present disclosure do not rely on the short-term data contained in short-term data signals 12-1, but to instead utilize the augments contained in the long-term data 12-2 to obtain the information that which is desired or needed by the execution protocol 14. The short-term data signals contained in short-term data 12-1 will store a buffer of a set amount and then will window out as time goes on or continues. Thus, as time goes on, data will be dropped from the short-term data 12-1 depending on priority or time.

The data that enters the framework 10 is streamed or received from signal data from the hardware, such as the sensor. Some exemplary hardware that may be coupled with the framework 10 is hardware from a EW system, such as EW sensors that track an incoming object or threat to a platform, which may be manned or unmanned. However, the exemplary hardware may also be non-military platforms, such as commercial or personal vehicles having sensors that track objects in relation to that platform. The streamed data is what defines the signals for short term data 12-1. The signals, which may be EW or RF signals or other signals, contain a significant amount of data about the object being tracked in relation to the platform. Framework 10 extracts pertinent information from the signals and organizes the data into the augments of the entity component system or long-term data 12-2.

Notably, ADS 12 includes the trigger list 12-3 and the request handler 12-4. The usage of the trigger list 12-3 enables asynchronous signaling to occur. Asynchronous signaling refers to the ability for signals to be processed simultaneously and process information for different signal generators (i.e., different hardware components) at the same time, and the ability to repeat or rerun the processing for a component. Essentially, asynchronous signaling refers to the ability to run multiple processing of the components based on different triggers at the same time and with no defined order, which is distinct and different from the previous pipeline, sequential or serial processing that was required.

The asynchronous signaling capabilities of framework 10 is accomplished by the triggering framework or triggering components used within framework 10. For example within the execution protocol 14 is the registered trigger 14-1 that is coupled with the trigger list 12-3 via link 16A. The trigger list 12-3 is coupled with the trigger receiver 14-2 via link 16B. The triggers are received at 14-2 when the trigger occurs. The received triggers at 14-2 are received into the framework 10. The framework 10 enables the system or a user to know when an event has happened to the database so that an algorithm can request the data, via data request 14-3, that the algorithm needs to utilize to execute the algorithm via algorithm execution 14-8. Accordingly the trigger receiver or received trigger 14-2 is coupled with the data request 14-3 via link 16C.

In one exemplary operation, when the algorithm 14-8 of the execution protocol 14 initializes, it instructs the database or ADS 12 which updates are relevant for algorithm execution 14-8. For example, with respect to an EW system, one exemplary update that can be utilized is pulse data or pulse repetition intervals (PRI). Then, if the database in ADS 12 identifies a modification to a PRI value, then the database or ADS 12 will broadcast to the entire framework 10 that there was an update to the PRI value from an emitter instance, wherein the emitter is one exemplary legacy hardware component of the EW system. In this example, that update of a change to the PRI value is the registered trigger at 14-1. The algorithm of the execution protocol 14 will receive the trigger (i.e., a change in PRI value or some other registered trigger) and update at 14-2 for that emitter instance. Then, the execution protocol 14 will request data at 14-3 that is needed to execute the algorithm at 14-8 for that instance. The requested data at 14-3 is sent to the request handler 12-4 via link 16D. The request handler 12-4 then sends retrieved data, as controlled data retrieval, via link 16E to the data receiver at 14-5. Once the data is received at 14-5 the received data may be transferred to the execution thread pool 14-6 via link 16F. There may be an indication or instruction that the data is ready for execution. This contains an indication that the retrieved augment data is ready for execution. For executing the algorithm at 14-8, framework 10 shall only need to receive the trigger at 14-1 from the database or ADS 12 that the trigger or update occurred and then the algorithm is automatically executed at 14-8.

The ADS 12 is agnostic to the data that it holds. For example, framework 10 can operate such that data can be requested from the ADS 12 using an identifier (ID) or data may be entered into the ADS 12 via an ID. Through the use of the ID, the framework 10 knows how many bytes of storage is needed for an augment. For example, there may be 100 or more IDs. Assume the 95^{th} ID is identified as ID-95 . Framework 10 may identify ID-95 as needing to be updated. During runtime, framework 10 can add information or data to ID-95 that can be later requested and retrieved for execution of other algorithms. The framework 10 will identify when ID-95 changes and results in a registered trigger from 14-1 that is received from the trigger list 12-3 into the execution protocol 14 at the received trigger 14-2.

In one exemplary operation, the trigger list 12-3 takes a poll of data that is of concern to the framework 10, and more particularly needed for the algorithm to be executed at 14-8, and when that data changes, the trigger list 12-3 will identify whether one of the identifiers or IDs have a value that has changed or deviated in a manner that would require the algorithm to automatically run again.

Another exemplary feature of the present disclosure is that the triggers are registered in a generic manner. The triggers are registered in a generic and open way to allow third-party developers using an appropriate API and software development kit to write an algorithm that pulls data from the ADS 12 and modify the data to allow a third-party to interact with framework 10 without the developer of framework 10 being involved in future development.

In yet another example, the triggers that are registered at 14-1 know what augments are in the long-term data 12-2. More particularly, and in another example, the triggers know the IDs of each augment. Thus, the trigger does not need to be cognizant of anything other than the IDs in order to complete the request from the requested data 14-3 in the request handler 12-4. However the algorithm executed at 14-8 will understand that particular ID is associated with a particular data structure, such as PRI, bandwidth, frequency or the like.

Because framework 10 is a framework, it is not specific to the data that is stored within ADS 12. This configuration makes framework 10 powerful to be able to write algorithms that are focused on the data and not concern the system designers on other factures like when the algorithm is to be run and at what order it is to be run.

Another aspect of the framework that can be implemented is that there are encrypted messages for registering triggers and receiving the triggers. This would occur through a protected mode of transferring messages between the ADS 12 and the algorithm execution protocol 14 in an encrypted manner. Further, there may be separate keys or separate levels of encryption depending on the protocols and algorithms to be executed by framework 10.

Framework 10 improves computer processing efficiency because framework 10 is able to process multiple signals at a single time though different algorithms. Recall, previous techniques utilized a pipeline approach that processed data serially. However now, through the use of the execution thread pool 14-6, it enables parallelization of different algorithms to be executed simultaneously on different emitters or signal generators via legacy hardware, such as the EW system. The EW system being the system that reads and digitizes the signals being broadcast or emitted by the emitters. The parallelization or the algorithms is represented by the execution thread pool 14-6. In one example, framework 10 is loaded with algorithms that fit a certain API into a shell that runs the algorithm and maintains the triggering and data reception, however it may instruct the algorithm execution 14 to run multiple, such as five or more, instances of the same algorithm. Thus, if one instance is busy operating on data then the other instances are able to accept and process data which improves throughput over the previous pipeline techniques. Recall, the previous pipeline techniques would only enable the processing to occur at the speed of its slowest algorithm. However, now through the parallelization of the algorithm via the execution thread pool 14-6, framework 10 can scale through multiple threads and cores to process data quicker. Therefore, it results in significant throughput processing improvement.

In another exemplary operation, the triggers are registered at the registered trigger 14-1 at the startup. The registered trigger from 14-1 is sent via link 16A to the active data storage 12, namely, to the trigger list 12-3. The registered trigger is then saved into the trigger list 12-3 such that the ADS 12 knows whether the algorithm wants a particular piece of data. That particular piece of data may be known by its ID. The ADS 12 is then aware that the algorithm inserted at 14-8 is concerned with a particular trigger, such as a change in PRI. For example algorithm ID-103 may be registered for augment ID-95 in the trigger list 12-3. Then, if a change occurs to an augment, and in this example if a change occurred to augment ID-95, then a trigger message is sent from the ADS 12 via link 16B to be received at 14-2. Once the trigger has been received at 14-2, the algorithm execution 14 will identify that data needs to be requested at 14-3. The data to be requested at 14-3 will have received the trigger via link 16C. Once the trigger has been received, additional data may be requested via link 16D to the request handler 12-4. Notably the data that is requested into the request handler 12-4 does not need to be the same augments that generated the initial trigger. For example, if a change in PRI occurs (i.e., a change to ID-95), then data that can be requested can be the geolocation of that augment at the time at which PRI changed. The request handler 12-4 performs a database lookup function to pull the requested data from 14-3. Then, the request handler transmits the controller data retrieval via link 16E until it is received at 14-5. The received data 14-5 is the impetus for the algorithm at 14-8 to run once the received data 14-5 is transmitted via link 16F to the execution thread pool 14-6. If the algorithm execution threads 14-6 are not available immediately, then the data across link 16F may be buffered until one of the execution threads at 14-6 are available.

The persistent queries 14-4 is another example of one instantiation of the present disclosure that can be used to query data. The persistent queries 14-4 request data in the background instead of constantly polling the database. The persistent queries 14-4 can identify certain data, such as comparing data to other emitters or other hardware signal generators. Thus, the persistent queries can establish factors of comparing data for all of the emitters or signal generators at a certain frequency.

In one example, the persistent queries will have a local copy of one of the arrays in the database that holds an augment so that the persistent queries do not need to constantly poll the database and request data for every single emitters frequency information or emitter information or PRI information, as the case may be. Stated otherwise, the persistent queries 14-4 can occur at a fixed rate that may be slower, as determined by the system engineer designing or EW Subject Matter Expert, the algorithm 14-8, to determine how out of date the data can be and still have an operational algorithm 14-8.

For example, the persistent queries 14-4 can be programmed to run or examine data every thirty seconds to determine what data is present. This is different from the trigger which would indicate every time the registered trigger changes in the trigger list. In another example, one of the triggers may be a timer. Thus, one trigger may be set up to trigger at a fixed interval, such as every thirty seconds. However what maintains the data fresh is the persistent query 14-4 which runs at a certain rate and that is built into the algorithms programmer's API. The algorithm programmer can setup a persistent query 14-4 to identify data at a certain rate to obtain information relating to new or changes in PRI augments or frequency augments. The persistent queries 14-4 will effectuate the reception of this data from the ADS 12 asynchronous to the execution of the algorithm at 14-8. This enables the algorithms themselves to compare the received data 14-5 from to the data received from the persistent queries 14-4 instead of having to poll the database for emitter information at every emitter or signal generator instance.

The pending data 14-7 portion of the execution thread pool 14-6 is the part of the algorithm that will service the queue for when the data is received at 14-5 and sent to the execution thread pool 14-6 to be a link 16F. Thus, when the algorithm is not executing on data, such as when there is no data to process, the pending for data 14-7 box represents that the execution thread pools 14-6 are waiting for new data to be received into the execution thread pools 14-6.

The post results 14-9 represents changes that the algorithm determines needs to be made to augments that are in the long-term data 12-2 of the ADS 12. Thus, the post results 14-9 is a feedback mechanism that enables the algorithm to determine what augments need to change or be added or deleted in response to determinations made by algorithm executed at 14-8. One of the outputs of the algorithm API at 14-8 is an action queue of items that the algorithm must or would like to alter in the database or long-term data augments 12-2 in ADS 12. For example there may be an indication from the algorithm execution 14-8 that pulse information has been received and it produces a geolocation. Therefore, the post results 14-9 can indicate that a latitude and longitude need to be inserted into the database of long-term data 12-2 for that particular emitter instance.

Framework 10 may run on any type of processor card or system on a chip. Alternatively, framework 10 could operate on multiple PCs or multiple processor cards inasmuch as the components of framework 10 may be networked together via links 16. For example, the ADS 12 could be located on a first processor and the algorithm execution 14 could be located on one or multiple other processors. However, it is contemplated that framework 10 would be located on a single processor card, preferably on a platform such as an aircraft, regardless of whether it is manned or unmanned. This particular processor card hosting framework 10 would be part of an EW system on the platform.

Although the present disclosure has primarily been discussed with respect to EW systems, there are other commercial applications as well. For example this technology of framework 10 could be expanded to other distributed networks that need to obtain augments from a database. For example there may be diagnostic data in a car or vehicle that needs to be reviewed. For example if the short-term data signals 12-1 were diagnostic information about a car, such as tire pressure or any other sensor information or inputs. Then those sensor inputs, such as tire pressure at a given time, are placed into augments into the long-term data storage 12-2 and then there are the algorithms that process the augments in accordance with that which is shown by framework 10. In this example, if the tire pressure deviated from a registered trigger then the framework 10 would enable the algorithm to request data via 14-3 into the request handler 12-4 that could obtain the time or temperature or some other information about the vehicle when that deviation or trigger occurred. The algorithm may be executed at 14-8 based on the augments relating to the received data and preform a subsequent action via the posted results 14-9, such as initiating a warning light on the vehicle's dashboard.

As described herein, aspects of the present disclosure may include one or more electrical or other similar secondary components and/or systems therein. The present disclosure is therefore contemplated and will be understood to include any necessary operational components thereof. For example, electrical components will be understood to include any suitable and necessary wiring, fuses, or the like for normal operation thereof. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” or “protocols” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A computer program product including least one non-transitory computer readable storage medium in operative communication with a processor and a framework comprising an active data storage and an execution protocol, wherein the execution protocol is coupled with the active data storage, the storage medium having instructions stored thereon that, when executed by the processor, implement a method for asynchronous signal processing, the instructions comprising:
register a trigger and transmitting the registered trigger to a trigger list in the active data storage, wherein the trigger is associated with an augment stored in a database in the active data storage, wherein the trigger changes in response to one or more signals received into the active data storage;
retrieve augment data from the active data storage in response to the trigger changing;
receive the retrieved augment data in the execution protocol;
provide an indication to an execution thread pool that the retrieved augment data is ready for execution, wherein the execution thread pool includes multiple execution threads that operate in parallel to execute one or more instances of algorithms at the same time; and
execute one or more algorithms on different but parallel threads of the execution thread pool at the same time, wherein execution of at least one of the one or more algorithms is based on the retrieved augment data.

2. The computer program product of claim 1, wherein the instructions further comprise:
receive signals at a first digital receiver on a platform from a first signal generator remote from the platform;
receive signals from a second signal generator remote from the platform;
execute, via a first application program interface (API), a first algorithm in a first thread of the execution thread pool based on augments associated with the signals received from the first signal generator;
execute, via the first API, a second algorithm in a second thread of the execution thread pool based on augments associated with the signals received from the second signal generator, wherein the second thread operates in parallel with the first thread in the execution thread pool.

3. The computer program product of claim 2, wherein the instructions further comprise:
determine whether one of the threads in the execution thread pool is occupied by that thread executing another algorithm, and if that thread is occupied then executing, via another API, another algorithm in another thread that operates in parallel with the thread that is occupied; and
buffer the received and retrieved augment data in the event that all of threads are occupied.

4. The computer program product of claim 1, wherein the instructions further comprise
retrieve the augment based on an identifier; and
provide only the identifier and the augment to a first application program interface (API) for executing a first algorithm.

5. The computer program product of claim 1, wherein the instructions further comprise:
query the augment data in the active data storage via persistent queries that are asynchronous to the registered trigger; and
compare queried augment data with the retrieved augment data associated with the trigger.

6. The computer program product of claim 5, wherein the instructions further comprise:
schedule the persistent queries to query data in the active data storage at regular intervals; and
maintain a local copy of data in the active data storage so that the persistent queries do not need to constantly poll the active data storage.

7. The computer program product of claim 1, wherein the instructions further comprise:
provide feedback to the active data storage in response to execution of the at least two algorithms on different but parallel threads of the execution thread pool at the same time; and
change an augment in the active data storage in response to the feedback, wherein changing the augment is accomplished by inserting additional data into the augment that was produced during execution of the at least two algorithms on different but parallel threads of the execution thread pool at the same time.

8. A computer implemented method for asynchronous signal processing, the method comprising:
obtaining a framework comprising an active data storage and an execution protocol, wherein the execution protocol is coupled with the active data storage;
registering a trigger and transmitting the registered trigger to a trigger list in the active data storage, wherein the trigger is associated with an augment stored in a database in the active data storage, wherein the trigger changes in response to one or more signals received into the active data storage;
retrieving augment data from the active data storage in response to the trigger changing;
receiving the retrieved augment data in the execution protocol;
providing an indication to an execution thread pool that the retrieved augment data is ready for execution, wherein the execution thread pool includes multiple execution threads that operate in parallel to execute one or more instances of algorithms at the same time; and
executing one or more algorithms on different but parallel threads of the execution thread pool at the same time, wherein execution of at least one of the one or more algorithms is based on the retrieved augment data.

9. The method of claim 8, wherein executing at least two algorithms on different but parallel threads of the execution thread pool at the same time comprises:
receiving signals at a first digital receiver on a platform from a first signal generator remote from the platform;
receiving signals from a second signal generator remote from the platform;
executing, via a first application program interface (API), a first algorithm in a first thread of the execution thread pool based on augments associated with the signals received from the first signal generator;
executing, via the API, a second algorithm in a second thread of the execution thread pool based on augments associated with the signals received from the second signal generator, wherein the second thread operates in parallel with the first thread in the execution thread pool.

10. The method of claim 9, further comprising:
determining whether one of the threads in the execution thread pool is occupied by that thread executing another algorithm, and if that thread is occupied then executing, via another API, another algorithm in another thread that operates in parallel with the thread that is occupied.

11. The method of claim 10, further comprising:
buffering the received and retrieved augment data in the event that all of threads are occupied.

12. The method of claim 9, further comprising:
removing the first algorithm from the first thread; and
inserting a third algorithm into the first thread to replace the first algorithm.

13. The method of claim 8, further comprising:
retrieving the augment based on an identifier; and
providing only the identifier and the augment to a first application program interface (API) for executing a first algorithm.

14. The method of claim 8, further comprising:
querying the augment data in the active data storage via persistent queries that are asynchronous to the registered trigger; and
comparing queried augment data with the retrieved augment data associated with the trigger.

15. The method of claim 14, further comprising:
scheduling the persistent queries to query the augment data in the active data storage at regular intervals;
maintaining a local copy of data in the active data storage so that the persistent queries do not need to constantly poll the active data storage.

16. The method of claim 8, further comprising:
providing feedback to the active data storage in response to execution of the at least two algorithms on different but parallel threads of the execution thread pool at the same time; and
changing an augment in the active data storage in response to the feedback, wherein changing the augment is accomplished by inserting additional data into the augment that was produced during execution of the at least two algorithms on different but parallel threads of the execution thread pool at the same time.

17. A framework for asynchronous signal processing, the framework comprising:
an active data storage including a first data storage and a second data storage, wherein the first data storage includes data signals and the second data storage includes augments; and the active data storage further including a trigger list and a request handler; and
an execution protocol, wherein the execution protocol is coupled with the active data storage; and the execution protocol including a registered trigger, a trigger receiver, a data requester, and a data receiver; and the execution protocol including an execution thread pool having at least two parallel threads, wherein the least two parallel threads asynchronously execute two algorithms, respectively, based on the augments.

18. The framework of claim 17, further comprising:
a first application program interface (API) for executing a first algorithm in a first thread that is one of the least two parallel threads of the execution thread pool based on augments associated with signals received from a first signal generator located remote from a platform, wherein the active data storage is on the platform; and
a second API for executing a second algorithm in a second thread that is one of the least two parallel threads of the execution thread pool based on augments associated with signals received from a second signal generator located remote from the platform.

19. The framework of claim 17, further comprising:
an identifier associated with each of the augments, wherein execution on at least one of the two algorithms is based, at least in part, on the identifier.

20. The framework of claim 17, further comprising:
a persistent query coupled to the data requester.
